(19) United States
(12) Patent Application Publication
(10) Pub. No.: US 2016/0224126 A1
(43) Pub. Date: Aug. 4, 2016

(54) USING WEARABLES TO CONTROL ANOTHER DEVICE

(71) Applicant: Google Inc., Mountain View, CA (US)

(72) Inventors: Eve Astrid Andersson, Brooklyn, NY (US); Tiruvilwamalai Venkatram Raman, San Jose, CA (US); Casey John Burkhardt, Mountain View, CA (US); John Ove Peter Lundblad, Milpitas, CA (US); David Tseng, San Jose, CA (US); Charles L. Chen, Sunnyvale, CA (US); Ying Zheng, Mountain View, CA (US)

(73) Assignee: Google Inc., Mountain View, CA (US)

(21) Appl. No.: 14/256,104

(22) Filed: Apr. 18, 2014

(51) Int. Cl. G06F 3/03

(52) U.S. Cl. CPC G06F 3/03

(57) ABSTRACT

Methods, systems, and apparatus, including computer programs encoded on computer storage media, for controlling a user device with a wearable device. One of the methods includes receiving, by a user device and from a wearable device, data sets that each represent a sequence of physical positions of the wearable device in response to movement of the wearable device, determining, for each data set, whether the data set indicates a predetermined sequence of positions of the wearable device, for only each data set determined to indicate a predetermined sequence of positions of the wearable device, determining a predetermined sequence of actions to perform on the user device that correspond with the predetermined sequence of positions, and for only each data set determined not to indicate a predetermined sequence of positions of the wearable device, not taking an action in response to the data set.

### BACKGROUND

This specification relates to user control of a first device with a second, wearable device.

There are many ways of controlling a user device. For example, many tactile user inputs facilitate the control of user devices. Additionally, a user may provide voice commands to a user device, e.g., a laptop, tablet, or smart phone, in addition to or instead of using on screen user interface controls. The voice commands may instruct the user device to perform a specific action or request information from the user device, such as search results. The user device may launch one or more applications, e.g., a web browser, in response to a voice command while performing the specific action. Some user devices also interpret motions as user input signals.

### SUMMARY

In general, one innovative aspect of the subject matter described in this specification can be embodied in methods that include the actions of receiving, by a user device and from a wearable device, the wearable device being a device that is separate from the user device, data sets that each represent a sequence of physical positions of the wearable device in response to movement of the wearable device, determining, by the user device and for each data set, whether the data set indicates a predetermined sequence of positions of the wearable device, for only each data set determined to indicate a predetermined sequence of positions of the wearable device, determining, by the user device, a predetermined sequence of actions to perform on the user device that correspond with the predetermined sequence of positions, and for only each data set determined not to indicate a predetermined sequence of positions of the wearable device, not taking an action in response to the data set. Other embodiments of this aspect include corresponding computer systems, apparatus, and computer programs recorded on one or more computer storage devices, each configured to perform the actions of the methods. A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions.

The foregoing and other embodiments can each optionally include one or more of the following features, alone or in combination. The method may include performing, by the user device, the predetermined sequence of actions. The method may include identifying, by the user device, an application that corresponds to an action in the predetermined sequence of actions, and executing, by the user device, the identified application. The method may include providing, by the user device, a command, from the predetermined sequence of actions, to the identified application.

In some implementations, the method includes, for at least one data set, determining, by the user device, that the predetermined sequence of actions of the data set specifies a variable parameter, and determining, by the user device, a value for the variable parameter based on at least a proper subset of the sequence of positions of the predetermined sequence of positions. The variable parameter may include an alarm time. The method may include receiving, by the user device, first input from a user identifying the predetermined sequence of positions. The method may include receiving, by the user device, second input from the user associating the predetermined sequence of positions with the predetermined sequence of actions.

In some implementations, determining whether the data set indicates the predetermined sequence of positions includes determining, by the user device, whether the data set indicates that the wearable device maintained a first position in the predetermined sequence of positions for a predetermined period of time. Determining whether the data set indicates the predetermined sequence of positions may include determining, by the user device, whether the data set indicates that the wearable device maintained a first position and a second position discrete from the first position, wherein both the first position and the second position correspond to the predetermined sequence of actions. The method may include receiving, by the user device, input from a user associating at least the first position and the second position with the predetermined sequence of actions, wherein, upon determining that the wearable device maintained at least two of the positions associated with the predetermined sequence of actions, the user device performs the predetermined sequence of actions.

The subject matter described in this specification can be implemented in particular embodiments so as to realize one or more of the following advantages. In some implementations, the use of a wearable device to control another device may allow a user to operate the other device when the user is not physically able to interact with the other device, e.g., when the user is not able to select an icon on a display of the other device. For example, a user might be using their hands for another task, might not have fine motor control of their hands, or might not have the use of their hands. In some implementations, the other device is programmable to allow a user to customize a sequence of physical locations of a wearable device and/or a sequence of actions. In some implementations, the programmability may allow flexibility for different users who may have different needs, e.g., as to which actions the other device preforms, and different capabilities, e.g., a first user may be able to use a first type of wearable device but not a second type of wearable device, etc. In some implementations, a sequence of actions may include a selection of multiple user interface elements that each correspond with the same sequence to reduce the likelihood of an accidental activation of the sequence of actions.

The details of one or more embodiments of the subject matter of this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is an example environment in which a wearable device sends physical position information to a user device.

FIG. 2A is an example user interface for a wearable device.

FIG. 2B is an example of an environment in which positions of a wearable device are mapped to user device actions.

FIG. 3 is a flow diagram of a process for determining a sequence of actions using data representing a sequence of physical positions of a wearable device.

FIG. 4 is a block diagram of a computing system that can be used in connection with computer-implemented methods described in this document.

Like reference numbers and designations in the various drawings indicate like elements.

### DETAILED DESCRIPTION

### 1.0 Overview

Sometimes a user may want to operate a user device, such as a smart phone, and be unable to do so, e.g., when the user is carrying several packages. For instance, the user may want to change a song that they are listening to or listen to a recent news articles.

The user may operate a wearable device, separate from the user device, to control the user device, by moving the wearable device through a sequence of physical positions that correspond to a predetermined action or sequence of actions. The user device receives a data set that represents the sequence of physical positions, identifies the predetermined action that corresponds with the sequence of physical positions, and performs the predetermined action.

Examples of sequences that correspond to actions are illustrative. For instance, when the user moves a head-mounted wearable device up, to the left, pauses for eight seconds, and then moves the head-mounted wearable device down, the user device receives data from the wearable device representing the physical positions and dwell times and may set an alarm to 8AM and turn the alarm on. When the user moves the head-mounted wearable device up, to the right, and down and speaks the phrase “wearable devices,” the user device receives data from the wearable device that represents the physical positions of the wearable device and may read a news article about wearable devices to the user.

The user may customize the sequences of physical positions and the sequences of actions. For example, a first user without the user of their hands may specify a sequence of physical positions for a head-mounted gyration device and a second user with limited motor control of their hands may specify a different sequence of physical positions for a smart watch such that corresponding user devices operated by the users perform the same sequence of actions in response to detection of the different sequences of physical positions.

### 1.1 Example Operating Environment

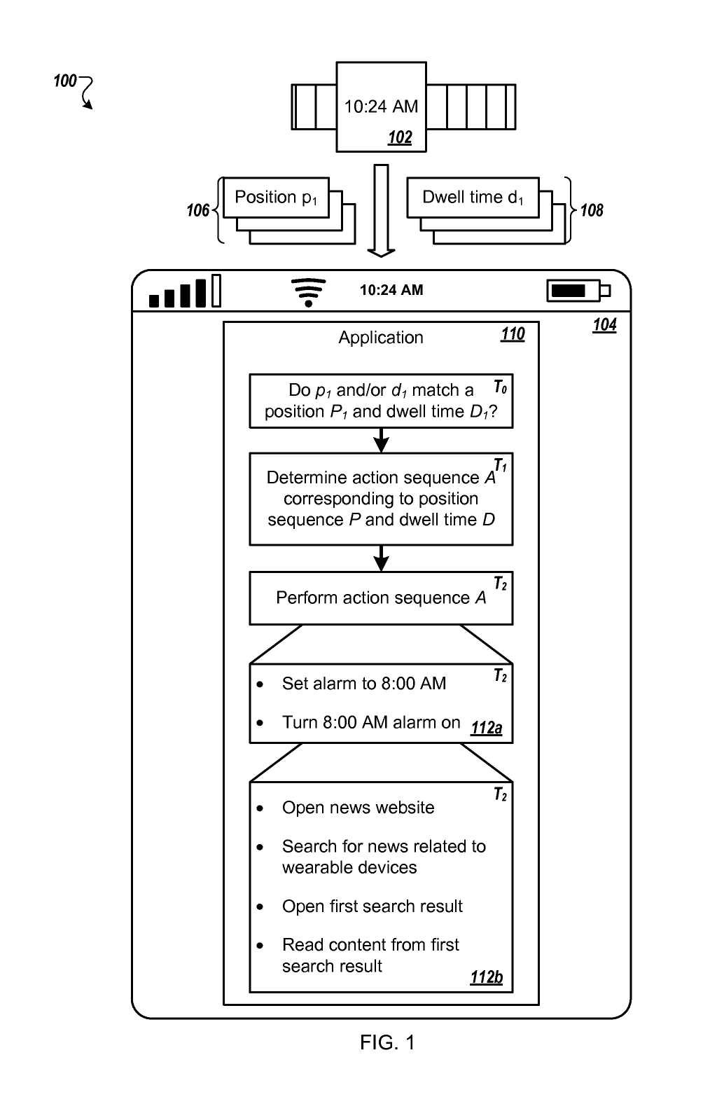

FIG. 1 is an example environment 100 in which a wearable device 102 sends physical position information to a user device 104. For example, the user device 104 receives a data set of positions 106, p₁ through pₙ and, optionally, a data set of dwell times 108, d₁ through dₙ, that corresponds with the positions 106 from the wearable device 102. Other data, such as data describing acceleration and speed, may also be received. For the examples described below, however, only positions and dwell times are considered.

As used in this specification, a “position” may be measured relative to a reference point model on the wearable device, and the position may correspond to X, Y and Z coordinates for multiple points of the wearable device. For example, if the wearable device is worn on the head, turning the wearer's head left will result in rotation about the vertical Y axis. Thus, while the wearable device might occupy nearly the same physical space before and after movement, the position of the wearable device may have changed significantly based on the position modeling of the wearable device.

An application 110 on the user device 104 uses the data set of positions 106 to determine, during T₀, whether the positions, p₁ through pₙ, match a predetermined sequence of positions P. For example, the application 110 determines whether the first position p₁ of the wearable device 102 is the same as a first predetermined position P₁, the second position p₂ is the same as a second predetermined positions P₂, an so on, until the application 110 determines whether the data set of positions 106 indicates that the wearable device 102 moved through the predetermined sequence of positions P, including P₁ and P₂, or not.

Upon determining that the wearable device 102 moved through the predetermined sequence of positions P, the application 110 determines, during T₁, an action sequence A that corresponds with the predetermined sequence of positions P. The application 110 may use an application programming interface (API) to determine and/or perform the action sequence A. The user device 104 then performs the identified action sequence A during time T₂, e.g., by executing one or more API calls identified in the action sequence A.

For instance, the user device 104 may perform a first action sequence 112a that sets an alarm to 8 AM and turns the alarm on. Likewise, the user device 104 may perform a second action sequence 112b that opens a news website, searches for news related to “wearable devices,” opens the first search result, and reads the content from the first search result to the user. The search phrase “wearable devices” may be determined using the predetermined sequence of positions P or upon receipt of a digital representation of speech representing the phrase “wearable devices” by the user device 104, e.g., in response to the user saying “wearable devices” during or after moving the wearable device 102 through the sequence of physical positions.

The user device 104 continuously receives data from the wearable device 102 that represents the positions and/or the dwell times of the wearable device 102. The user device may 104 compare each position with all of the beginning positions of the predetermined sequences of positions stored in a memory of the user device 104 until the user device 104 identifies a match. The user device 104 may then compare the data for positions subsequent to the particular position to determine whether the sequence of data, as a data set of positions p, matches one of the predetermined sequences of positions P. The user device 104 may use any appropriate algorithm to create the data sets and/or determine whether a data set or sequence of position or dwell time data received from the wearable device 102 matches a predetermined sequence of positions P and/or a predetermined sequence of dwell times D.

In some examples, the application 110 may determine whether the data set of dwell times 108 indicate that the wearable device 102 maintained one or more of the positions P₁ through Pₙ from a predetermined sequence of positions P, for at least a minimum corresponding threshold dwell time D₁ through Dₙ from a predetermined sequence of dwell times D. For instance, if the wearable device 102 moved through each of the positions P₁ through Pₙ, but the dwell time d₅ was less than the predetermined dwell time D₅, the user device 104 will not perform the sequence of actions that corresponds with the predetermined sequence of positions P and the predetermined dwell times D. If the wearable device moves through each of the positions in P and each of the positions P has at least the minimum corresponding dwell time from D, the user device 104 will perform the sequence of actions that corresponds with the predetermined sequence of positions P and the predetermined dwell times D.

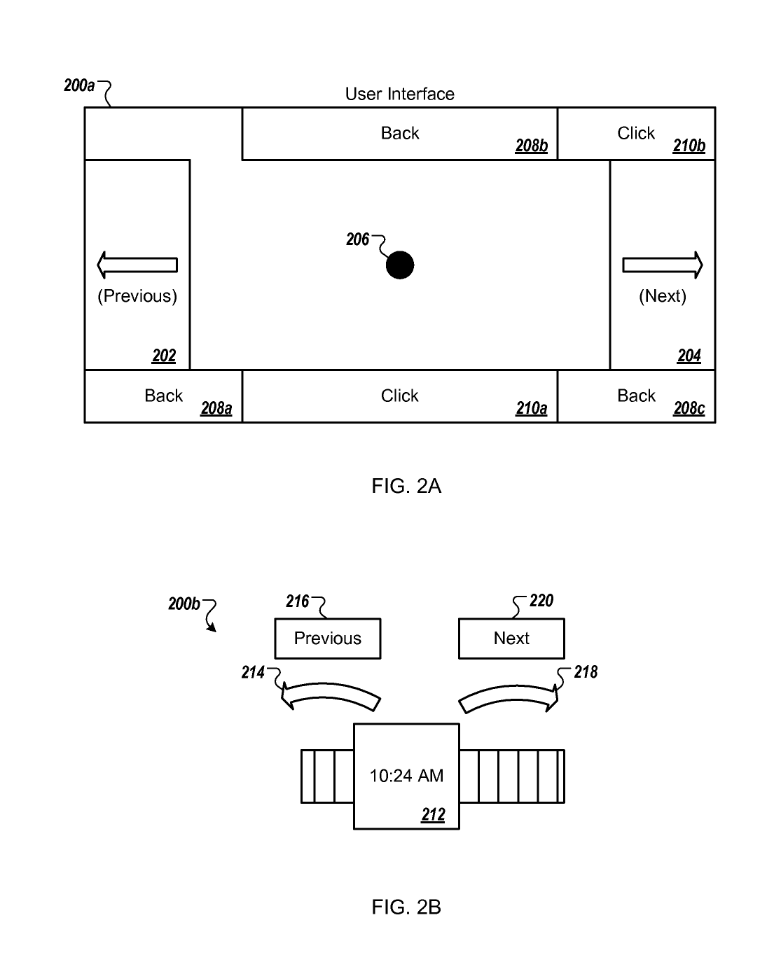

In some examples, the application 110 may determine whether the wearable device 102 maintained two or more positions for at least a corresponding threshold dwell time without consideration of the sequence of the positions. For instance, the application 110 may determine that the wearable device 102 maintained positions p₁ and p₂ for dwell times d₁ and d₂, respectively, that positions p₁ and p₂ match at least a subset of the positions in the predetermined sequence of positions P, and that the dwell times d₁ and d₂ are at least the same as corresponding dwell times identified in the dwell times D, as described in more detail below with reference to FIG. 2A.

The wearable device 102 and the user device 104 may communicate using Bluetooth, Wi-Fi, radio frequency, or any other appropriate wireless or wired technology. Some examples of wearable devices include head-mounted gyration devices, e.g., head-mounted controllers, head-mounted displays, head-mounted cameras, headsets, and smart glasses; smart watches; and health monitoring devices, e.g., activity trackers and fitness bands. Some examples of user devices include smart phones, vehicle user interfaces, laptops, desktops, and other types of computers.

### 1.2 Example Sequences of Physical Positions

FIG. 2A is an example user interface 200a for a wearable device. For example, the user interface 200a may be presented by a head-mounted display or a smart watch.

The user interface 200a includes multiple positions that each may correspond with at least one sequence of physical positions for the wearable device, e.g., the wearable device 102. For instance, when the wearable device is turned or moved to the left to select a previous element 202, the wearable device sends data to a user device that represents the left turn of the wearable device or movement of the wearable device to the left, respectively. In some examples, when the wearable device presents a user interface, the wearable device may send data to the user device that indicates selection of a particular position in the user interface, e.g., the previous element 202. The boundaries shown in FIG. 2A may be displayed in the user interface 200a, or may, instead, not be displayed so as to avoid user interface clutter.

When the wearable device is turned to the right to select a next element 204, the wearable device sends data to the user device that represents the right turn of the wearable device.

The movement of the wearable device may change a position of a selection element 206 that indicates the user selection of the positions in the user interface 200a. In some implementations, the position of the selection element 206 does not have a one to one correspondence with the movement of the wearable device. For example, when the user turns the wearable device to the right, the selection element 206 may move to an area in the next element 204 no matter the degree of rotation of the wearable device.

Selection of the previous element 202 and the next element 204 may cause a user device to move between previous and next slides in a picture slide show, between subsequent options in a menu of the user device, or perform any other appropriately programmed action.

The user interface 200a includes multiple back elements 208a-c and multiple click elements 210a-b. Upon selection of two or more of the back elements 208a-c, the wearable device may provide a user device with data representing the physical positions of the wearable device that correspond with the selected back elements or with data representing the selection of the multiple back elements. The user device may determine to perform a back action, or a sequence of actions, upon the receipt of the data, e.g., and go to a previous menu or perform another appropriate action.

The user device may perform the back action in response to the selection of two or more of the back elements 208a-c as part of a verification process to ensure that the selection of a single back element was not accidental. For instance, the selection of a first back element 208a and a second back element 208b, without an intervening selection of another element, may indicate that the user selected the back action intentionally. Selection of the second back element 208b followed by selection of the first back element 208a, without an intervening selection of another element, may indicate user selection of the same sequence of actions as selection of the first back element 208a followed by selection of the second back element 208b.

In some implementations, the user device performs an action in response to receipt of data representing the selection of three or more elements, e.g., all of the back elements 208a-c, without an intervening selection of another element, prior to performing an action. The selection of three or more elements may include the selection of the same element multiple times.

For instance, in response to receipt of data representing the selection of a first click element 210a, a second click element 210b, and the first click element 210a, the user device may perform a click or selection option. In this example, if the user device received data indicating the selection of the second click element 210b once and the first click element 210a once, in any order, the user device would not perform any action.

FIG. 2B is an example of an environment 200b in which positions of a wearable device 212 are mapped to user device actions. For instance, when the wearable device 212 is rotated left 214, the wearable device 212 may provide the user device with data representing the rotation and the user device may perform a previous action 216, or any other action mapped to the left rotation 214 of the wearable device.

When the wearable device 212 is rotated right 218, the wearable device provides the user device with data representing the right rotation 218. The user device determines an action that corresponds with the right rotation 218 and performs the action, e.g., a next action 220.

Any sequence of physical positions of the wearable device 212 may be mapped to a sequence of one or more actions that a user device will perform.

In some examples, when the wearable device 212 presents the user interface 200a on a display, the user interface 200a may provide a user with instructions regarding which physical positions or sequences of physical positions correspond with particular actions or sequences of actions. For instance, the wearable device 212 may present a sequence of user interfaces that each show the actions currently available based on a current sequence of physical positions of the wearable device 212 and the next physical position in the sequence to take for the user device to perform a particular action.

### 2.0 Example Process Flow

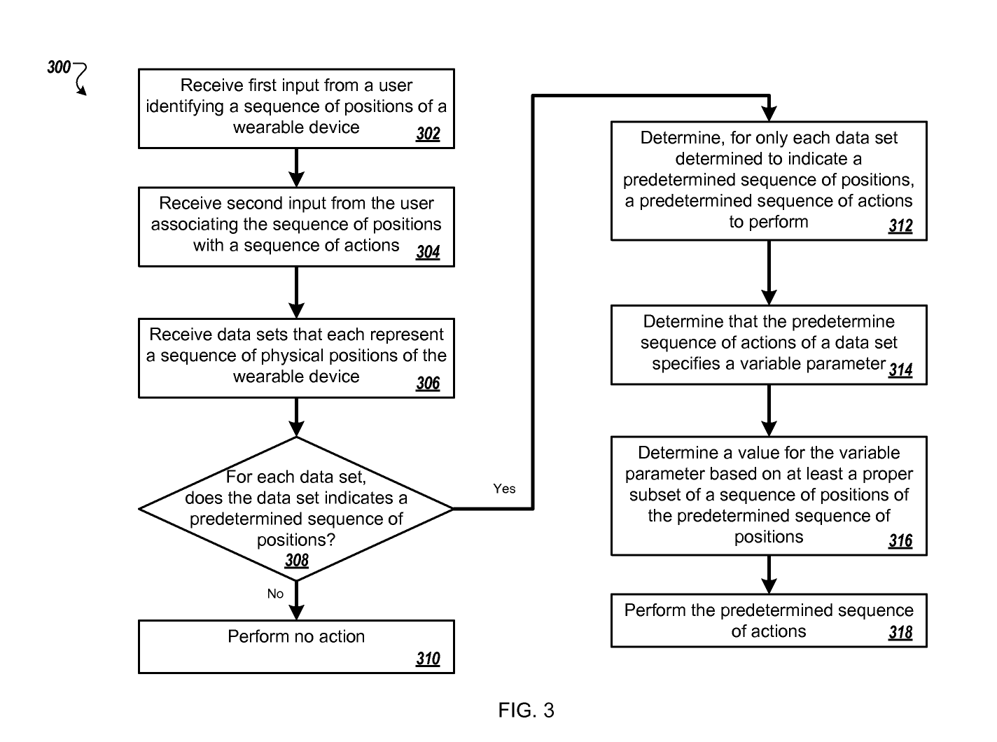

FIG. 3 is a flow diagram of a process 300 for determining a sequence of actions using data representing a sequence of physical positions of a wearable device. For example, the process 300 can be used by the user device 104 from the environment 100.

The user device receives first input from a user identifying a sequence of positions of a wearable device (302). For example, the first input may identify a first position and a second position for the wearable device. The first input may include a minimum dwell time for one or both of the first and second positions. The minimum dwell times for the first and second positions may be the same or may be different.

The sequence of positions may be entered by the user, may be included on the user device, e.g., as part of an application, the API and/or included in a list of sequences, or a combination of the two. For instance, the user may select a sequence position template and modify the positions included in the template.

The user device receives second input from the user associating the sequence of positions with a sequence of actions (304). The user may enter the sequence of actions, select a sequence of actions included on the user device, e.g., as a template in an application, the API and/or included in a list of sequences, or a combination of the two.

The user device receives data sets that each represent a sequence of physical positions of the wearable device (306). For example, as the user moves the wearable device, the user device receives data from the wearable device that indicates the positions of the wearable device. The user device combines the data representing discrete positions of the wearable device to create the data sets.

Some of the data sets may be overlapping, e.g., data representing a discrete position of the wearable device begins a new data set and is included in previous data sets. A data set may have a predetermined length or a maximum length. The length of a data set may be determined based on a sequence of matching positions represented by the data set and a predetermined sequence of positions, e.g., the user device may perform steps 306 and 308 together.

The user device determines, for each data set, whether the data set indicates a predetermined sequence of positions (308). For instance, the user device determines whether the data set matches the sequence of positions of the wearable device identified by the user in step 302. The user device may compare a particular data set with multiple predetermined sequences of positions, e.g., when the user device performs steps 302 and 304 multiple times for different sequences of actions.

In some examples, the user device may determine whether the respective data set indicates that the wearable device maintained a both first position and a second position discrete from the first position that are included in the predetermined sequence of positions. The user device may determine whether the respective data set indicates that one or both of the first position and the second position were maintained for a minimum dwell time, e.g., identified in the predetermined sequence of positions. The minimum dwell times for the first position and the second position may have the same minimum duration or different minimum durations. The predetermined sequence of positions may include a predetermined sequence of dwell times that each correspond to one of the positions.

For example, the user device compares at least some of the data from each data set with position sequence data, stored in a memory of the user device, representing one or more predetermined sequences of positions. The user device may compare the data set with the position sequence data until the user device determines that the data set matches one of the predetermined sequences of positions represented in the position sequence data. The user device may use any appropriate algorithm to determine whether the data set indicates the predetermined sequence of positions.

For each data set determined not to indicate a predetermined sequence of positions, the user device performs no action (310). For example, when the user device determines that a particular data set does not match any of the predetermined sequences of positions for the wearable device, the user device does not take any action. This may prevent the presentation of indications to a user asking if the user intended to perform one of the predetermined sequences of positions, e.g., when the user moved the wearable device and did not intend to active an action on the user device.

For only each data set determined to indicate a predetermined sequence of positions, the user device determines a predetermined sequence of actions to perform (312). The predetermined sequence of actions corresponds with the predetermined sequence of positions. For instance, the memory of the user device may include a mapping of predetermined sequences of positions to predetermined sequences of actions. The user device may use any appropriate algorithm to associate a particular sequence of actions with a corresponding sequence of positions.

The user device determines that the predetermined sequence of actions of a data set specifies a variable parameter (314). For instance, one of the positions in the predetermined sequence of actions is not associated with a fixed physical position of the wearable device and can be one of multiple different positions and/or dwell times. The user device may determine which of the multiple different positions and/or dwell times was performed by the wearable device.

The user device determines a value for the variable parameter based on at least a proper subset of a sequence of positions of the predetermined sequence of positions (316). For example, the user device uses the determination of which of the multiple different positions and/or dwell times was performed by the wearable device to determine the value for the variable parameter. In some examples, the variable parameter may be a duration for an alarm or a timer or may be an alarm time. The duration or alarm time may be determined using dwell time of the wearable device at a particular physical position in the predetermined sequence of physical positions.

The user device performs the predetermined sequence of actions (318). For instance, the user device may identify an application that corresponds with one of the actions in the predetermined sequence of actions, execute the identified action, and provide a command, from the predetermined sequence of actions, to the identified application. In some examples, the identified application may already be executing on the user device and the user device provides the command to the application.

The predetermined sequence of actions may include a single action or multiple actions.

The order of steps in the process 300 described above is illustrative only, and determining the sequence of actions to perform based on the sequence of physical positions of the wearable device can be performed in different orders. For example, the user device may receive the second input identifying the predetermined sequence of actions prior to receiving the first input identifying the predetermined sequence of positions of the wearable device.

In some implementations, the process 300 can include additional steps, fewer steps, or some of the steps can be divided into multiple steps. For example, the process 300 may include only steps 306 through 312 and not steps 302, 304, and 314 through 318.

### 3.0 Optional Implementation Details

In some implementations, the user device includes multiple modules or applications. For example, a first module may receive the data set of positions 106 and the data set of dwell times 108 from the wearable device 102 and determine whether the data sets indicate that the wearable device 102 moved through a predetermined sequence of positions P. Upon determining that the wearable device 102 moved through a predetermined sequence of positions, the first module may identify a corresponding sequence of actions A for the user device and provide an identification of the corresponding sequence of actions A to a second module that then preforms at least some the identified actions and/or causes at least some of the actions to be performed, e.g., by an application executing on the user device. One or both of the modules may correspond with their own API.

In some implementations, the application 110, the first module, and/or the second module may be an accessibility application or module included on the user device 104. An API that corresponds with the application or module may be an accessibility API.

In some implementations, the user device may receive physical position data from the wearable device that includes a relative magnitude of movement. For instance, the user device may receive physical position data from the wearable device that indicates that the wearable device rotated 22° to the left and determine whether one of the predetermined sequences of positions represented in a memory of the user device include a 22° left rotation. The amount of rotation may be used as a variable parameter or as a specific position in a predetermined sequence of positions.

The user device may use a magnitude of movement of the wearable device without having a one to one correspondence between a pointer presented on the user device and the magnitude of movement. For instance, the user device may not include a pointer, e.g., and be a touch screen device, and may use the magnitude of movement to identify a particular position in a sequence of positions of the wearable device.

### 4.0 Additional Implementation Details

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non-transitory program carrier for execution by, or to control the operation of, data processing apparatus. Alternatively or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus. The computer storage medium can be a machine-readable storage device, a machine-readable storage substrate, a random or serial access memory device, or a combination of one or more of them.

The term “data processing apparatus” refers to data processing hardware and encompasses all kinds of apparatus, devices, and machines for processing data, including by way of example a programmable processor, a computer, or multiple processors or computers. The apparatus can also be or further include special purpose logic circuitry, e.g., an FPGA (field programmable gate array) or an ASIC (application-specific integrated circuit). The apparatus can optionally include, in addition to hardware, code that creates an execution environment for computer programs, e.g., code that constitutes processor firmware, a protocol stack, a database management system, an operating system, or a combination of one or more of them.

A computer program, which may also be referred to or described as a program, software, a software application, a module, a software module, a script, or code, can be written in any form of programming language, including compiled or interpreted languages, or declarative or procedural languages, and it can be deployed in any form, including as a stand-alone program or as a module, component, subroutine, or other unit suitable for use in a computing environment. A computer program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub-programs, or portions of code. A computer program can be deployed to be executed on one computer or on multiple computers that are located at one site or distributed across multiple sites and interconnected by a communication network.

The processes and logic flows described in this specification can be performed by one or more programmable computers executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application-specific integrated circuit).

Computers suitable for the execution of a computer program include, by way of example, general or special purpose microprocessors or both, or any other kind of central processing unit. Generally, a central processing unit will receive instructions and data from a read-only memory or a random access memory or both. The essential elements of a computer are a central processing unit for performing or executing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer-readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (LAN) and a wide area network (WAN), e.g., the Internet.

The computing system can include clients and servers. A client and server are generally remote from each other and typically interact through a communication network. The relationship of client and server arises by virtue of computer programs running on the respective computers and having a client-server relationship to each other. In some embodiments, a server transmits data, e.g., an HTML page, to a user device, e.g., for purposes of displaying data to and receiving user input from a user interacting with the user device, which acts as a client. Data generated at the user device, e.g., a result of the user interaction, can be received from the user device at the server.

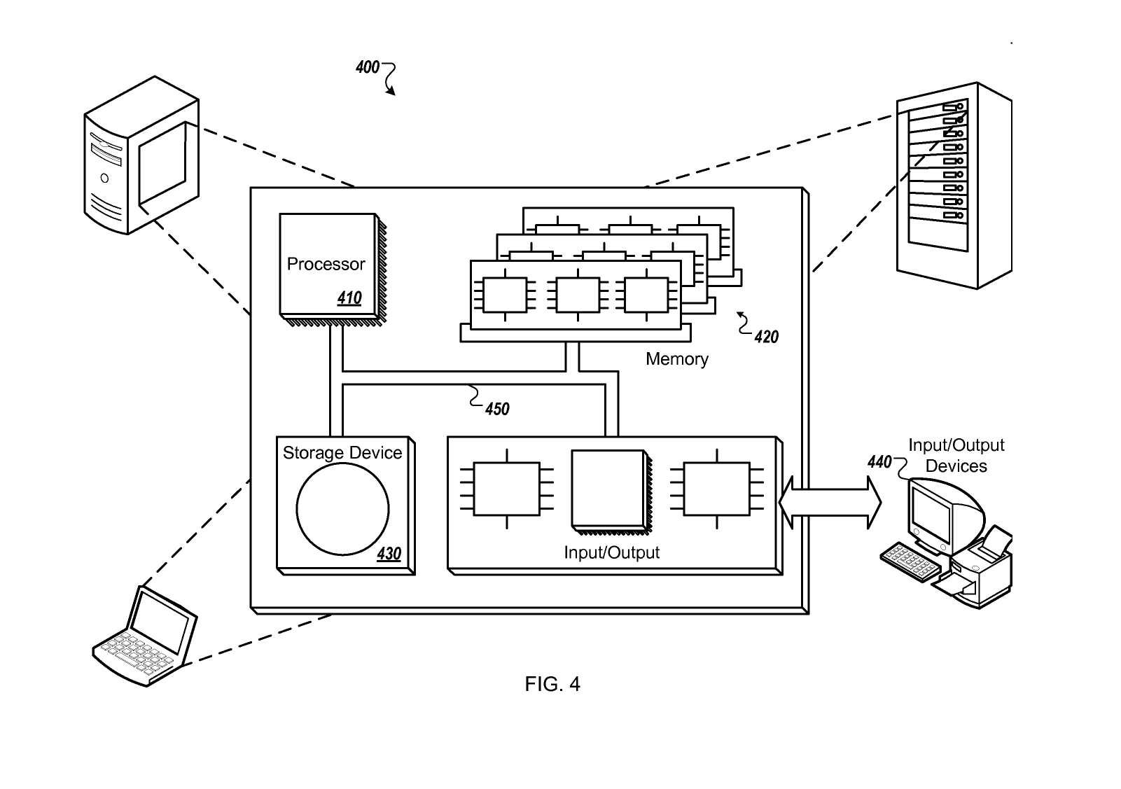

An example of one such type of computer is shown in FIG. 4, which shows a schematic diagram of a generic computer system 400. The system 400 can be used for the operations described in association with any of the computer-implement methods described previously, according to one implementation. The system 400 includes a processor 410, a memory 420, a storage device 430, and an input/output device 440. Each of the components 410, 420, 430, and 440 are interconnected using a system bus 450. The processor 410 is capable of processing instructions for execution within the system 400. In one implementation, the processor 410 is a single-threaded processor. In another implementation, the processor 410 is a multi-threaded processor. The processor 410 is capable of processing instructions stored in the memory 420 or on the storage device 430 to display graphical information for a user interface on the input/output device 440.

The memory 420 stores information within the system 400. In one implementation, the memory 420 is a computer-readable medium. In one implementation, the memory 420 is a volatile memory unit. In another implementation, the memory 420 is a non-volatile memory unit.

The storage device 430 is capable of providing mass storage for the system 400. In one implementation, the storage device 430 is a computer-readable medium. In various different implementations, the storage device 430 may be a floppy disk device, a hard disk device, an optical disk device, or a tape device.

The input/output device 440 provides input/output operations for the system 400. In one implementation, the input/output device 440 includes a keyboard and/or pointing device. In another implementation, the input/output device 440 includes a display unit for displaying graphical user interfaces.

While this specification contains many specific implementation details, these should not be construed as limitations on the scope of any invention or on the scope of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

What is claimed is:

1. A computer-implemented method comprising:
receiving, by a user device and from a wearable device that is a separate device from the user device, data sets that each represent a sequence of physical positions of the wearable device in response to movement of the wearable device;
for each of the data sets, determining, by the user device, whether the data set indicates a predetermined sequence of positions of the wearable device;
for only each data set determined to indicate a predetermined sequence of positions of the wearable device, determining, by the user device, a predetermined sequence of actions to perform on the user device that correspond with the predetermined sequence of positions;
for at least one pair of data sets that includes a first data set and a second data set both of which are determined to indicate the same predetermined sequence of positions of the wearable device and a particular predetermined sequence of actions that includes a variable parameter associated with a spoken phrase:
determining, by the user device for the first data set, a first value for the variable parameter based on a first spoken phrase uttered by a user;
performing, by the user device for the first data set, the particular predetermined sequence of actions using the first value for the variable parameter;
determining, by the user device for the second data set, a second value for the variable parameter based on a second spoken phrase uttered by a user, the second value being a different value than the first value; and
performing, by the user device for the second data set, the particular predetermined sequence of actions using the second value for the variable parameter; and
for only each data set determined not to indicate a predetermined sequence of positions of the wearable device, not taking an action in response to the data set.

2. (canceled)

3. The method of claim 1, comprising:
identifying, by the user device, an application that corresponds to an action in the predetermined sequence of actions; and
executing, by the user device, the identified application.

4. The method of claim 3, comprising:
providing, by the user device, a command, from the predetermined sequence of actions, to the identified application.

5. (canceled)

6. The method of claim 1, wherein determining, by the user device for the first data set, the first value for the variable parameter based on a first spoken phrase uttered by a user comprises determining an alarm time using the first spoken phrase.

7. The method of claim 1, comprising:
receiving, by the user device during a customization process, first input from a user identifying the predetermined sequence of positions; and
receiving, by the user device during the customization process, second input from the user associating the predetermined sequence of positions with the predetermined sequence of actions.

8. (canceled)

9. The method of claim 1, wherein determining whether the data set indicates the predetermined sequence of positions comprises determining, by the user device, whether the data set indicates that the wearable device maintained a first position in the predetermined sequence of positions for at least a minimum threshold dwell time.

10. The method of claim 1, wherein determining whether the data set indicates the predetermined sequence of positions comprises determining, by the user device, whether the data set indicates that the wearable device maintained a first position and a second position discrete from the first position, wherein both the first position and the second position correspond to the predetermined sequence of actions.

11. The method of claim 10, comprising:
receiving, by the user device during a customization process, input from a user associating at least the first position and the second position with the predetermined sequence of actions, wherein, upon determining that the wearable device maintained at least two of the positions associated with the predetermined sequence of actions, the user device performs the predetermined sequence of actions.

12. A system, comprising:
a data processing apparatus; and
a non-transitory computer readable storage medium in data communication with the data processing apparatus and storing instructions executable by the data processing apparatus and upon such execution cause the data processing apparatus to perform operations comprising:
receiving, by a user device and from a wearable device that is a separate device from the user device, data sets that each represent a sequence of physical positions of the wearable device in response to movement of the wearable device;
for each of the data sets, determining, by the user device, whether the data set indicates a predetermined sequence of positions of the wearable device;
for only each data set determined to indicate a predetermined sequence of positions of the wearable device, determining, by the user device, a predetermined sequence of actions to perform on the user device that correspond with the predetermined sequence of positions;
for at least one pair of data sets that includes a first data set and a second data set both of which are determined to indicate the same predetermined sequence of positions of the wearable device and a particular predetermined sequence of actions that includes a variable parameter associated with a spoken phrase:
determining, by the user device for the first data set, a first value for the variable parameter based on a first spoken phrase uttered by a user;
performing, by the user device for the first data set, the particular predetermined sequence of actions using the first value for the variable parameter;
determining, by the user device for the second data set, a second value for the variable parameter based on a second spoken phrase uttered by a user, the second value being a different value than the first value; and
performing, by the user device for the second data set, the particular predetermined sequence of actions using the second value for the variable parameter; and
for only each data set determined not to indicate a predetermined sequence of positions of the wearable device, not taking an action in response to the data set.

13. (canceled)

14. The system of claim 12, the operations comprising:
identifying, by the user device, an application that corresponds to an action in the predetermined sequence of actions; and
executing, by the user device, the identified application.

15. (canceled)

16. The system of claim 12, wherein determining whether the data set indicates the predetermined sequence of positions comprises determining, by the user device, whether the data set indicates that the wearable device maintained a first position in the predetermined sequence of positions for at least a minimum threshold dwell time.

17. The system of claim 12, wherein determining whether the data set indicates the predetermined sequence of positions comprises determining, by the user device, whether the data set indicates that the wearable device maintained a first position and a second position discrete from the first position, wherein both the first position and the second position correspond to the predetermined sequence of actions.

18. A non-transitory computer readable storage medium storing instructions executable by a data processing apparatus and upon such execution cause the data processing apparatus to perform operations comprising:
receiving, by a user device and from a wearable device that is a separate device from the user device, data sets that each represent a sequence of physical positions of the wearable device in response to movement of the wearable device;
for each of the data sets, determining, by the user device, whether the data set indicates a predetermined sequence of positions of the wearable device;
for only each data set determined to indicate a predetermined sequence of positions of the wearable device, determining, by the user device, a predetermined sequence of actions to perform on the user device that correspond with the predetermined sequence of positions;
for at least one pair of data sets that includes a first data set and a second data set both of which are determined to indicate the same predetermined sequence of positions of the wearable device and a particular predetermined sequence of actions that includes a variable parameter associated with a spoken phrase:
determining, by the user device for the first data set, a first value for the variable parameter based on a first spoken phrase uttered by a user;
performing, by the user device for the first data set, the particular predetermined sequence of actions using the first value for the variable parameter;
determining, by the user device for the second data set, a second value for the variable parameter based on a second spoken phrase uttered by a user, the second value being a different value than the first value; and
performing, by the user device for the second data set, the particular predetermined sequence of actions using the second value for the variable parameter; and
for only each data set determined not to indicate a predetermined sequence of positions of the wearable device, not taking an action in response to the data set.

19. (canceled)

20. The computer readable storage medium of claim 18, the operations comprising:
identifying, by the user device, an application that corresponds to an action in the predetermined sequence of actions; and
executing, by the user device, the identified application.

21. (canceled)

22. The computer readable storage medium of claim 18, wherein determining whether the data set indicates the predetermined sequence of positions comprises determining, by the user device, whether the data set indicates that the wearable device maintained a first position in the predetermined sequence of positions for at least a minimum threshold dwell time.

23. The computer readable storage medium of claim 18, wherein determining whether the data set indicates the predetermined sequence of positions comprises determining, by the user device, whether the data set indicates that the wearable device maintained a first position and a second position discrete from the first position, wherein both the first position and the second position correspond to the predetermined sequence of actions.

24. The method of claim 1, wherein receiving the data sets that each represent a sequence of physical positions of the wearable device in response to movement of the wearable device comprises receiving the data sets that each include relative magnitudes of movement of the wearable device from one physical position to the subsequent physical position.

25. The method of claim 1, wherein:
determining, by the user device for the first data set, a predetermined sequence of actions to perform on the user device that correspond with the predetermined sequence of positions comprises determining a predetermined sequence of actions to perform to set an alarm; and
determining, by the user device for the first data set, the first value for the variable parameter using the first spoken phrase comprises determining an alarm time for the alarm using the first spoken phrase.

26. The method of claim 1, wherein:
determining, by the user device for the first data set, a predetermined sequence of actions to perform on the user device that correspond with the predetermined sequence of positions comprises determining the predetermined sequence of actions to perform a search; and
determining, by the user device for the first data set, the first value for the variable parameter using the first spoken phrase comprises determining one or more keywords for the search using the first spoken phrase.
